(19) United States
(12) Patent Application Publication
(10) Pub. No.: US 2014/0337062 A1
(43) Pub. Date: Nov. 13, 2014

(54) CARD PRESENT FRAUD PREVENTION METHOD USING AIRLINE PASSENGER DETAIL

(71) Applicant: MASTERCARD INTERNATIONAL INCORPORATED, Purchase, NY (US)

(72) Inventor: Justin X. Howe, Oakdale, NY (US)

(73) Assignee: MASTERCARD INTERNATIONAL INCORPORATED, Purchase, NY (US)

(21) Appl. No.: 13/890,518

(22) Filed: May 9, 2013

(51) Int. Cl. G06Q 10/02; G06Q 20/40

(52) U.S. Cl. CPC G06Q 10/02; G06Q 20/40
USPC 705/5

(57) ABSTRACT

A system, method, and computer-readable storage medium configured to process cross-border transactions involving payment cards.

### BACKGROUND

1. Field of the Invention

Aspects of the disclosure relate in general to financial services. Aspects include an apparatus, a method and system to provide a decision making platform to process cross-border transactions involving payment cards, and more particularly to a network-based system and method that provide a computer-related platform for decision making based on an accessibility to multiple transaction scoring engines, at least a portion of the scoring engines determining fraud risk for cross-border transactions involving payment cards.

2. Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards. Payment cards provide the clients of a financial institution (“cardholders”) with the ability to pay for goods and services without the inconvenience of using cash.

The payment industry suffers from problems stemming from cross-border travel by cardholders. One problem is that fraud rates in cross-border transactions (in which the cardholder is from a different country than a merchant) are much higher than those experienced on domestic transactions. These high fraud rates make it risky for the card issuing financial institution (“issuers”) to approve cross-border transactions. As a result, issuers often attempt to mitigate the risk by declining cross-border transactions at higher rates than domestic transactions. While these higher decline rates may minimize the issuing bank's fraud exposure, it inconveniences the cardholder, deprives the merchant of a sale, and deprives the issuer of incremental revenue on the purchase.

Generally, at least one payment card network currently provides fraud scoring for payment card transactions. Fraud scoring refers to an indication, or likelihood, that a payment transaction is fraudulent. In one fraud scoring system, the payment card network provides a number back to the payment card issuer between zero and 1,000, which translates into zero and 100 percent, in tenths of percentage points. To provide fraud-scoring capability, various vendors or payment card companies provide and market various different fraud scoring products. A payment card company generally selects one of the vendor products to provide its customers (the card issuers) with one of fraud scoring and credit risk scoring that is accessible, for example, on a payment card network.

### SUMMARY

Embodiments include a system, device, method and computer-readable medium to process cross-border transactions involving payment cards.

In one embodiment, a system receives, via a network interface, transaction data from a merchant bank. The transaction data includes a primary account number (PAN) associated with a customer, and addenda for the transaction data. A processor extracts travel information from the addenda, the travel information including an anticipated date of travel and an anticipated location. A white list entry associated with the primary account number is stored in a database. The white list entry contains the anticipated date of travel and the anticipated travel location.

In yet another embodiment, a system receives, via a network interface, transaction data from a merchant bank. The transaction data includes a primary account number associated with a customer, and a transaction origin location for the financial transaction. A white list entry associated with the primary account number is retrieved from a database. The white list entry contains anticipated dates of travel and anticipated travel location. A processor determines whether a current date and the transaction origin location fall within the anticipated dates of travel and anticipated travel location. The financial transaction is scored with the processor, at least in part on whether the current date and the transaction origin location fall within the anticipated dates of travel and anticipated travel location. The network interface transmits either the transaction score to an issuer, or an approval/rejection of the financial transaction to the merchant bank based on the transaction score.

### BRIEF DESCRIPTION OF THE DRAWINGS

FIG. 1 is a block diagram illustrating a cross-border financial transaction using a payment card network.

FIG. 2 is an expanded block diagram of an exemplary embodiment of a server architecture of a payment processor embodiment configured to process a cross-border financial transaction.

FIG. 3 illustrates a non-real time clearing process of white listing future travel data.

FIG. 4 illustrates an alternate (rules based) method of authorizing a cross-border transaction.

### DETAILED DESCRIPTION

One aspect of the disclosure includes the realization that anticipated cardholder travel data may be incorporated as a factor to vendor fraud scoring products in the authorization of cross-border transactions. Further, a system and method may parse anticipated cardholder travel from cardholder travel purchases. In such a system, the payment card network combines the anticipated travel into a travel database.

While embodiments described herein are applied to a cross-border context, it is understood by those familiar with the art that the concepts, apparatus, system and methods described herein may also be applicable to domestic travel that is far from a cardholder's usual area of residence.

In an alternate embodiment, a travel-rules based engine may be used in addition to score-based fraud detector.

The systems and processes are not limited to the specific embodiments described herein. In addition, components of each system and each process can be practiced independently and separately from other components and processes described herein. Each component and process also can be used in combination with other assembly packages and processes.

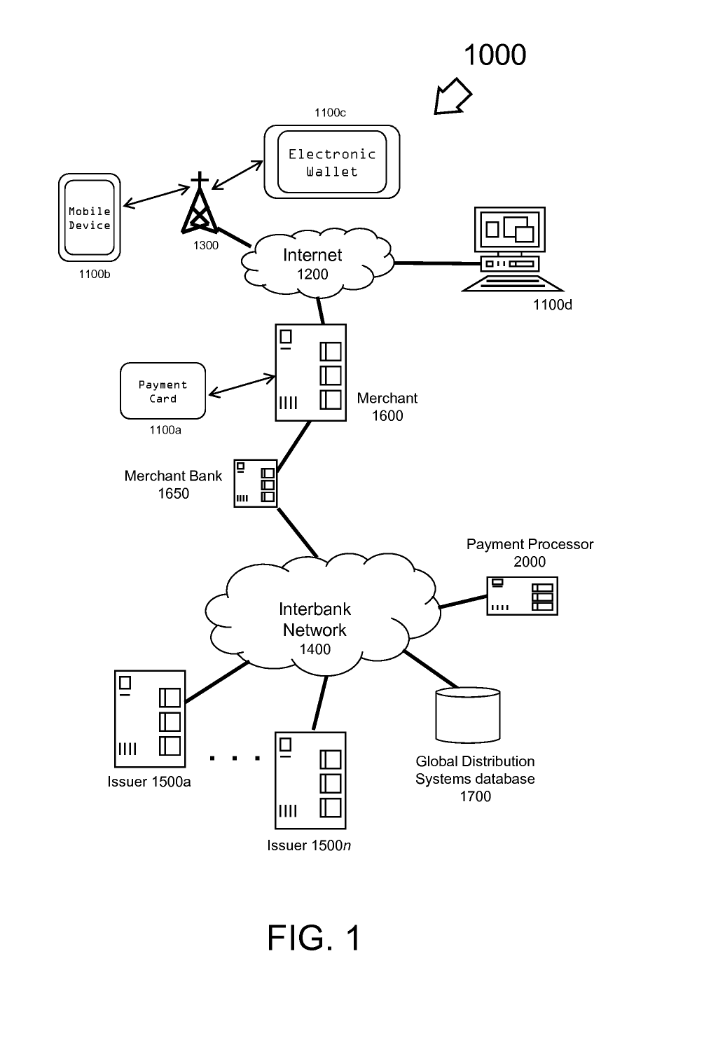

FIG. 1 is a block diagram 1000 illustrating a typical cross-border financial transaction using a payment card payment system. The present disclosure is related to a payment card payment system, such as a credit card payment system using the MasterCard® interchange, Cirrus® network, or Maestro®. The MasterCard interchange is a proprietary communications standard promulgated by MasterCard International Incorporated for the exchange of financial transaction data between financial institutions that are customers of MasterCard International Incorporated. Cirrus is a worldwide interbank network 1400 operated by MasterCard International Incorporated linking debit and payment cards to a network of ATMs throughout the world. Maestro is a multi-national debit card service owned by MasterCard International Incorporated.

In a financial payment system, a financial institution called the “issuer” 1500 issues a payment card to a consumer, who uses payment card 1100a to tender payment for a cross-border purchase from a merchant 1600 or withdraw cash from an Automated Teller Machine. In addition to payment cards 1100a, it is understood by those familiar with the art that the process herein applies equally to mobile device 1100b (such as key fobs, mobile phones, tablet computers, and the like), electronic wallets 1100c, or computers 1100d, connected to merchant 1600 via a mobile telephone network 1300 or the internet 1200.

In this example, a user presents the payment card to a point-of-sale device at a merchant 1600. The merchant is affiliated with a financial institution. This financial institution is usually called the “merchant bank” or the “acquiring bank” or “acquirer bank” 1650. When a payment card 1100a is tendered at a merchant 1600, the merchant 1600 electronically requests authorization from the merchant bank 1650 for the amount of the purchase. The request is performed electronically with the consumer's account information from the magnetic stripe on the payment card or via a computer chip imbedded within the card 1100a. The account information is forwarded to transaction processing computers of the merchant bank 1650. Alternatively, a merchant bank 1650 may authorize a third party to perform transaction processing on its behalf. In this case, the merchant 1600 will be configured to communicate with the third party. Such a third party is usually called a “merchant processor” or an “acquiring processor.”

Using a payment processor 2000, the computers of the merchant bank 1650 or the merchant processor will communicate via an interbank network 1400 with the computers of the issuer bank 1500 to determine whether the consumer's account is in good standing and whether the cross-border transaction is likely to be fraudulent. As part of the fraud determination, payment processor 2000 may utilize anticipated travel information that has been corrected by a Global Distribution Systems database 1700. Based on these determinations, the request for authorization will be declined or accepted. If the request is accepted, an authorization code is issued to the merchant 1600.

When a request for authorization is accepted, the available credit balance of cardholder's account is decreased.

After a transaction is captured, the transaction is settled between the merchant 1600, the merchant bank 1650, and the issuer 1500. As described herein, the term “payment card” includes cards such as credit cards, charge cards, and debit cards, but also includes any other devices that may hold payment account information, such as mobile phones, personal digital assistants (PDAs), and key fobs.

In embodiments of the current disclosure, payment processor 2000 is able to preemptively reject cross-border transactions based on rules, without seeking authorization from the issuer bank 1500. As will be described below, these rules may eliminate potential fraudulent transactions from occurring.

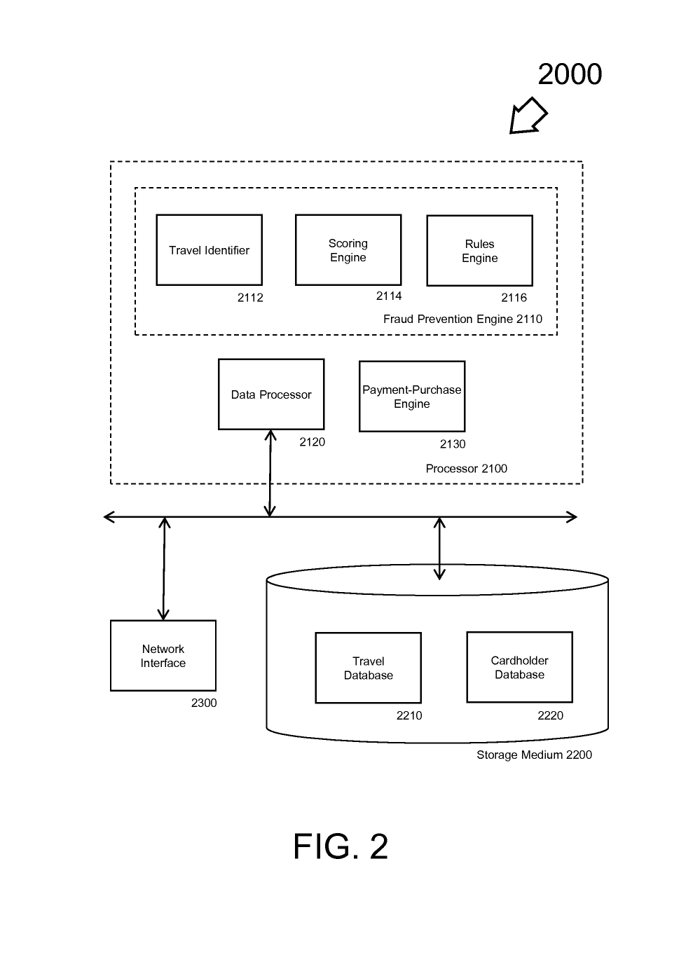

Embodiments will now be disclosed with reference to a block diagram of an exemplary payment processor server 2000 of FIG. 2, configured to enable a cross-border financial transaction, constructed and operative in accordance with an embodiment of the present disclosure.

Payment processor server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art.

As shown in FIG. 2, processor 2100 is functionally comprised of a fraud prevention engine 2110, a payment-purchase engine 2130, and a data processor 2120.

Data processor 2120 interfaces with storage media 2200 and network interface 2300. The data processor 2120 enables processor 2100 to locate data on, read data from, and writes data to, these components.

Payment-purchase engine 2130 performs payment and purchase transactions, and may do so in conjunction with fraud prevention engine 2110.

Fraud prevention engine 2110 is the structure that enables anti-fraud scoring or rules-based fraud-prevention of a financial transaction, and may further comprise: an travel identifier 2112, a scoring engine 2114 and/or a rules engine 2116.

Travel identifier 2112 analyzes the addenda of financial transactions to identify anticipated future travel by a cardholder.

Scoring engine 2114 is a structure configured to fraud score a financial transaction. Example scoring engines can be found in U.S. Pat. Nos. 7,428,509 and 8,126,791, both assigned to MasterCard International Incorporated. Additionally, in some embodiments, fraud prevention engine 2110 may have a rules engine to facilitate rules-based fraud-prevention algorithms.

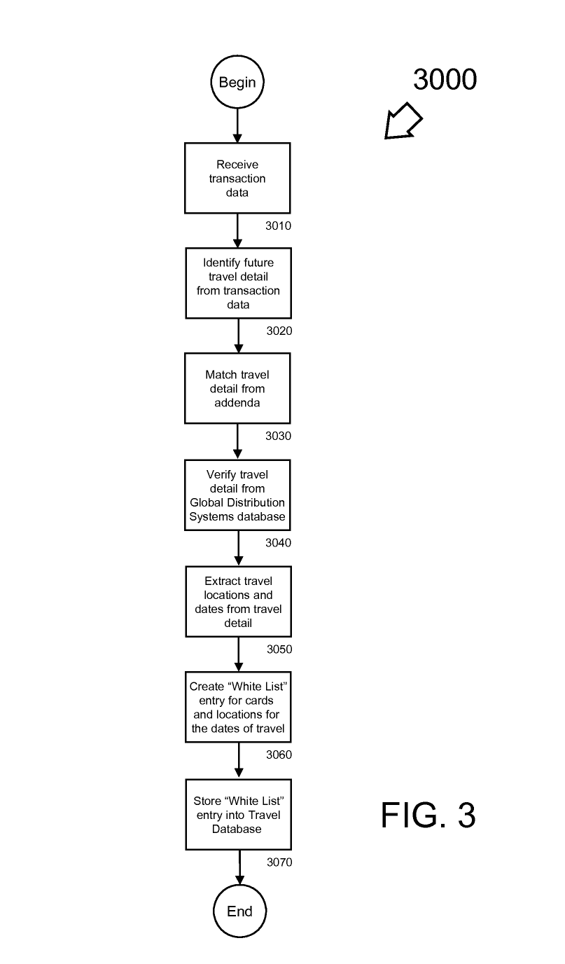

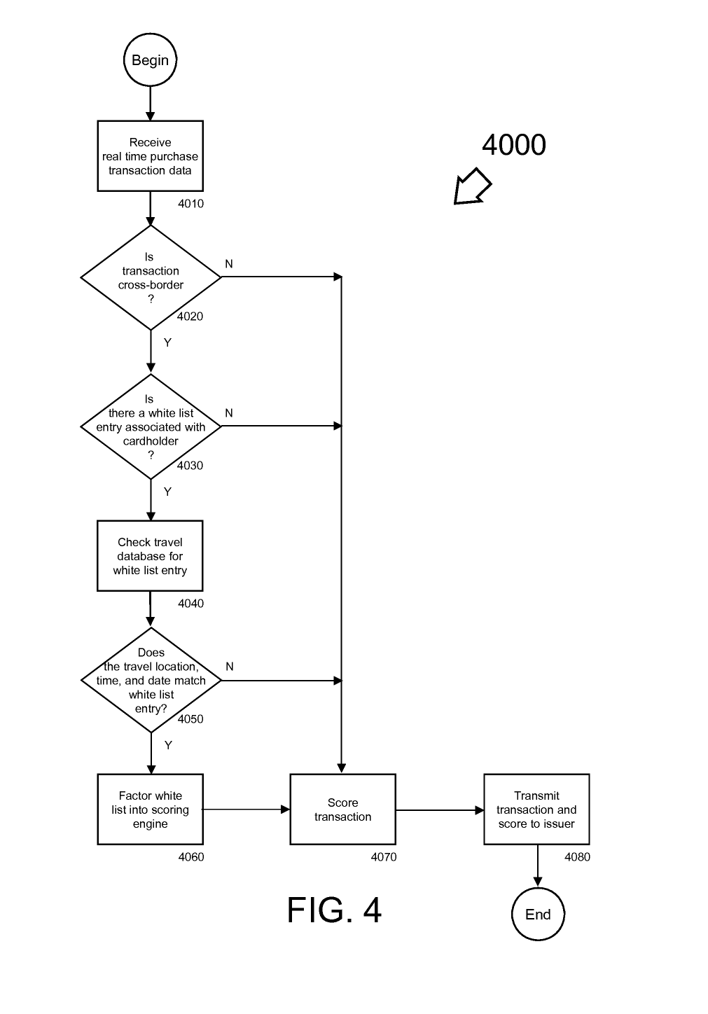

The functionality of all the fraud prevention engine 2110 structures is elaborated in greater detail in FIGS. 3 and 4.

These structures may be implemented as hardware, firmware, or software encoded on a computer readable medium, such as storage media 2200. Further details of these components are described with their relation to method embodiments below.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage media 2200 may be remotely located from processor 2100, and be connected to processor 2100 via a network such as a local area network (LAN), a wide area network (WAN), or the Internet.

In addition, as shown in FIG. 2, storage media 2200 may also contain a travel database 2210, and a cardholder database 2220. It is understood by those familiar with the art that one or more of these databases 2210-2220 may be combined in a myriad of combinations. Fraud prevention engine 2110 may store data related to cardholder payment credit, debit, or charge information in a cardholder database 2220. Additionally, travel database 2210 may store data related to anticipated cardholder travel.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment processor server 2000 to communicate with merchant 1100 and issuer 1200.

We now turn our attention to method or process embodiments of the present disclosure, FIGS. 3-4. It is understood by those known in the art that instructions for such method embodiments may be stored on their respective computer-readable memory and executed by their respective processors. It is understood by those skilled in the art that other equivalent implementations can exist without departing from the spirit or claims of the invention.

Embodiments create a spend-derived profile to anticipate cardholder travel to a destination. FIG. 3 illustrates a process 3000 in which anticipated travel is extracted from payment card transactions, constructed and operative in accordance with an embodiment of the present disclosure. It is understood by those familiar with the art that process 3000 may be a non-real time clearing process, but in alternate embodiments may be a real time process. Conventionally, a clearing process is a non-real time process.

At block 3010, payment processor 2000 receives transaction data from a merchant bank. The transaction data is received electronically via a network interface, and may be part of data from many transactions received via a batch process.

At block 3020, the travel identifier 2112 of the fraud prevention engine 2110 is identified from the batch-received transactions in order to identify future travel detail from transaction data.

At block 3030, travel identifier 2112 determines whether the travel-related transaction has correctly provided traveler itinerary information encoded within addenda associated with the travel-related transaction. These addenda messages are populated by travel providers (such as airlines) and travel agencies at the time payment for a booking is made. Such itinerary information may include the name of the traveler, the travel destination/departure points, and date of travel.

In some instances, the addenda are incomplete. In such instances, travel identifier 2112 verifies the travel itinerary information against a Global Distribution Systems database, block 3040. Such a database includes flight details, and pricing on many flights. As part of the verification process, the addenda are corrected and travel details are added, if necessary.

At block 3050, the transaction addenda data is parsed to determine itinerary information from the travel-related transaction dates, times, and location from travel-related transaction. The travel-related transaction data may relate to any travel-related data known in the art, such as a purchase or reservation of airline tickets, train tickets, bus tickets, hotel reservations or payments, rental car reservations, cruise tickets or reservations, or experience-ticket purchases (such as theater or show tickets).

At block 3060, a “white list” entry is created for travelers (and their associated Primary Account Numbers) and locations for the dates of travel. For example, if cardholder Denise purchases a round-trip airfare from Los Angeles to Vienna, Austria, departing on January 25th, and returning on February 14th, then a white list is created for the Primary Account Number associated with Denise, listing Vienna, Austria from January 25th through February 14th. Similarly, if cardholder Denise purchases opera tickets at the Salzburg Opera on January 27th, the white list may additionally have an entry for Salzburg, Austria on that date. In some embodiments, the white list entry may adjust or extrapolate location information to proximate locations, based on city, metropolitan area, county, state, province or country.

When no traveler information is listed in the addenda, the cardholder may be assumed to be the traveler.

When multiple travel tickets or reservations are made, the sub-process 3060 may be repeated for each traveler and their associated PANs. For example, if Denise purchases two airline tickets for herself and Karin, then the associated white list entry may be attached to Denise's account and Karin's account.

In some embodiments, a white list entry may be attached for the cardholder's other payment cards and their associated PANs. In some embodiments, the white list entries are attached to all cards, regardless of issuer, subject to opt-in by the cardholder. Suppose, for example, Denise may have purchased her travel tickets with a MasterCard®-branded payment card issued by the First National Bank of Gotham City. In such an embodiment, white list entries are attached to the card used, as well as any other card associated with Denise, such as Denise's MasterCard®-branded payment card issued by the Second National Bank of Metropolis.

At block 3070, the created white list entries are stored into a travel database 2210.

It is understood that embodiments of the disclosure use the white list as a factor in scoring payment card financial transactions.

FIG. 4 illustrates a real-time method 4000 that factors anticipated travel in fraud detection and scoring, constructed and operative in accordance with an embodiment of the present disclosure.

At block 4010, payment processor 2000 receives transaction request from a merchant bank. As mentioned above, the transaction request typically contains information such as the amount of the transaction and a Primary Account Number associated with the payment card, and the (location) origin of the transaction.

At block 4020, fraud prevention engine 2110 determines whether the transaction is a cross-border transaction. If not, flow continues at block 4070. If the transaction is a cross-border transaction, flow continues at block 4030.

If the transaction is a cross-border transaction, scoring engine 2114 or rules engine 2116 checks travel database 2210 to determine if there is a white list entry associated with the cardholder, block 4040. If no white list entry exists, the process flow continues at block 4070.

If a white list entry exists, it is retrieved at block 4040.

The transaction location, time and date are compared with the white list entry at block 4050. Process 4000 may automatically adjust the time and date for the time zone of the transaction origin. If the transaction does not fit within the white list entry, the process flow continues at block 4070.

If the transaction does fits within the time, date, and location information of the white list entry, the white list information is added as a factor for the scoring engine, block 4060.

The transaction is scored at block 4070, at the score is transmitted along with the transaction information to the issuer, block 4080. With this information, an issuer may decide whether to permit or reject the transaction. It should be noted that due to the risk of many cross-border transactions, there is a high likelihood of a transaction being rejected as fraud when the white list information is not added as a factor for the transaction scoring at block 4070. In some embodiments where the payment processor 2000 is located at an issuer, the process authorizes or rejects the transaction directly. In yet other embodiments, payment processor 2000 may preemptively reject the transaction without consultation with the issuer, if the score from the score transaction is too low.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A real-time method of generating a white list for anticipated future travel, the method comprising:
receiving, via a network interface, transaction data from a merchant bank, the transaction data including a primary account number (PAN) associated with a customer, and addenda for the transaction data;
extracting, with a processor, travel information from the addenda, the travel information including an anticipated date of travel and an anticipated location;
storing, in a database, a white list entry associated with the primary account number, the white list entry containing the anticipated date of travel and the anticipated travel location.

2. The processing method of claim 1, wherein the travel information is verified against a Global Distribution Systems database.

3. The processing method of claim 2, further comprising:
extrapolating the anticipated travel location to a city.

4. The processing method of claim 2, further comprising:
extrapolating the anticipated travel location to a metropolitan area.

5. The processing method of claim 2, further comprising:
extrapolating the anticipated travel location to a state.

6. The processing method of claim 2, further comprising:
extrapolating the anticipated travel location to a county.

7. The processing method of claim 2, further comprising:
extrapolating the anticipated travel location to a province.

8. The processing method of claim 2, further comprising:
extrapolating the anticipated travel location to a country.

9. A real-time system of generating a white list for anticipated future travel, the system comprising:
a network interface configured to receive transaction data from a merchant bank, the transaction data including a primary account number (PAN) associated with a customer, and addenda for the transaction data;
extracting, with a processor, travel information from the addenda, the travel information including an anticipated date of travel and an anticipated location;
storing, in a database, a white list entry associated with the primary account number, the white list entry containing the anticipated date of travel and the anticipated travel location.

10. The system of claim 9, wherein the travel information is verified against a Global Distribution Systems database.

11. The system of claim 10, wherein the anticipated travel location is extrapolated to a city, metropolitan area, county, state, province or country.

12. A non-transitory computer readable medium encoded with data and instructions, when executed by a computing device the instructions causing the computing device to:
receive, via a network interface, transaction data from a merchant bank, the transaction data including a primary account number (PAN) associated with a customer, and addenda for the transaction data;
extract, with a processor, travel information from the addenda, the travel information including an anticipated date of travel and an anticipated location;
store, in a database, a white list entry associated with the primary account number, the white list entry containing the anticipated date of travel and the anticipated travel location.

13. The non-transitory computer readable medium of claim 12, wherein the travel information is verified against a Global Distribution Systems database.

14. The non-transitory computer readable medium of claim 13, wherein the anticipated travel location is extrapolated to a city, metropolitan area, county, state, province or country.

15. A real-time method of processing a financial transaction at a payment processor, the method comprising:
receiving, via a network interface, transaction data from a merchant bank, the transaction data including a primary account number (PAN) associated with a customer, and a transaction origin location for the financial transaction;
retrieving, from a database, a white list entry associated with the primary account number, the white list entry containing anticipated dates of travel and anticipated travel location;
determining, with a processor, whether a current date and the transaction origin location fall within the anticipated dates of travel and anticipated travel location;
scoring the financial transaction, with the processor, at least in part on whether the current date and the transaction origin location fall within the anticipated dates of travel and anticipated travel location, to create a transaction score; and
with the network interface, either: transmitting the transaction score to an issuer; or transmitting an approval or rejection of the financial transaction to the merchant bank based on the transaction score.

16. The processing method of claim 15, wherein the white list entry is generated at least in part by addenda of past financial transactions.

17. The processing method of claim 15, wherein the anticipated travel location is extrapolated to a city, metropolitan area, county, state, province or country, and the transaction origin location is compared to the extrapolated anticipated travel location.

18. A system located at a payment processor, the system comprising:
a network interface configured to receive transaction data about a financial transaction from a merchant bank, the transaction data including a primary account number (PAN) associated with a customer, and a transaction origin location for the financial transaction;
a database configured to store a white list entry associated with the primary account number, the white list entry containing anticipated dates of travel and anticipated travel location;
a processor configured to determine whether a current date and the transaction origin location fall within the anticipated dates of travel and anticipated travel location, and to score the financial transaction at least in part on whether the current date and the transaction origin location fall within the anticipated dates of travel and anticipated travel location, to create a transaction score; and
wherein the network interface is further configured to, either: transmit the transaction score to an issuer; or transmit an approval or rejection of the financial transaction to the merchant bank based on the transaction score.

19. The system of claim 18, wherein the white list entry is generated at least in part by addenda of past financial transactions.

20. The system of claim 18, wherein the anticipated travel location is extrapolated to a city, metropolitan area, county, state, province or country, and the transaction origin location is compared to the extrapolated anticipated travel location.

21. A non-transitory computer readable medium encoded with data and instructions, when executed by a computing device the instructions causing the computing device to:
receiving, via a network interface, transaction data from a merchant bank, the transaction data including a primary account number (PAN) associated with a customer, and a transaction origin location for the financial transaction;
retrieving, from a database, a white list entry associated with the primary account number, the white list entry containing anticipated dates of travel and anticipated travel location;
determining, with a processor, whether a current date and the transaction origin location fall within the anticipated dates of travel and anticipated travel location;
scoring the financial transaction, with the processor, at least in part on whether the current date and the transaction origin location fall within the anticipated dates of travel and anticipated travel location, to create a transaction score; and
with the network interface, either: transmitting the transaction score to an issuer; or transmitting an approval or rejection of the financial transaction to the merchant bank based on the transaction score.

22. The computer readable medium of claim 21, wherein the white list entry is generated at least in part by addenda of past financial transactions.

23. The computer readable medium of claim 21, wherein the anticipated travel location is extrapolated to a city, metropolitan area, county, state, province or country, and the transaction origin location is compared to the extrapolated anticipated travel location.
